(19) United States
(12) Patent Application Publication
(10) Pub. No.: US 2015/0084739 A1
(43) Pub. Date: Mar. 26, 2015

(54) KEYPAD ASSEMBLY AND METHOD TO ACCESS A CAR

(71) Applicant: EILEO, Paris (FR)

(72) Inventors: Thierry Lemoult, Chelles (FR); Guillaume Remond, Paris (FR); Juan-Luis Morel, Chatenay-Malabry (FR)

(21) Appl. No.: 14/394,877

(22) PCT Filed: Apr. 10, 2013
(86) PCT No.: PCT/EP2013/057422

§ 371 Date: Oct. 16, 2014

(30) Foreign Application Priority Data
Apr. 18, 2012 (EP) 12305451.2

(51) Int. Cl. G07C 9/00; G06F 3/02

(52) U.S. Cl. CPC G07C 9/00174; G06F 3/0202
USPC 340/5.54

(57) ABSTRACT

A system is provided for vehicle access. Advantageously, the present system includes an optical keypad and an RFID antenna working through a windscreen which can be athermal including a thin metal layer. The keypad measures the reflection of visible light on the fingers of the user. The keypad assembly has very low power consumption as it includes a capacitive sensor for a standby mode. The capacitive sensor shape limits the induction with the RFD antenna. The present system therefore proposes a new access system for which the installation is fully reversible and not harmful to the vehicle.

The present invention relates to a keypad assembly and to a method to access a car, and more particularly to the automated car rental.

To simplify the way of renting a car, rental companies are largely implementing reservation systems via Internet or telephone. This is an automated rental where the user can directly access the reserved vehicle without possessing the key. To do this, one can use an RFID reader through the windscreen. This method is very suitable in the case of a regular user who was given an RFID card upon registration.

However this method is not possible in the case of an occasional user. Generally, the user does not have an RFID card. However, when booking, he was able to get a secret code (number and/or letters) in various ways: by a printed ticket terminal, SMS, email, etc.

The document US2010/0277320 A1 “RFID KEYPAD ASSEMBLIES” describes an RFID card integrating a keyboard used before an RFID card reader. Keys are depressible by a person's finger, each key being associated with a RFID transmitter and capable of enabling the transmitter to transmit a signal that may be read by the RFID reader.

However, in the car rental domain, such a system requires installation of the RFID card on the outer surface of the windscreen. The RFID card can collide with the wipers blades. Also the longevity of the card is limited due to external aggressions: rain, snow, pollution etc.

The document WO 2008/038899 A1 “RFID TERMINAL HAVING A PERSONAL AUTHENTICATION DEVICE” describes a portable device combining a keyboard and an RFID reader.

However, the disclosed device includes mechanical keys that require outdoor installation under climatic constraints, and therefore not sustainable in the long term. Moreover, the fragmented form of the terminal with a rear end, makes it difficult to install on a flat surface of a vehicle.

Capacitive keyboards exist and operate through glass. Such a keyboard is used for appliances or computer keyboards in the medical community due to hygiene issues. However this type of capacitive keyboard is not usable with athermal windscreens containing metal film which acts as an electrostatic shield. It makes the capacitive effect overall. With this type of windscreen, a windscreen, a capacitive keyboard can detect the approach of a finger without being able to determine the activated key.

In automotive systems, keyboards to access the vehicle are available on some vehicles as original equipment. This keyboard is located on the door near the handle. Installation is performed using an opening in the bodywork revealing the keyboard. Such an installation requires an opening in the door.

The present invention aims to propose a new car access system for which the installation is completely reversible and not harmful to the car.

The present invention also aims to propose a new system that works with all types of windscreen including athermal screen with a thin metal layer blocking radio waves.

Another object of the invention is to provide a new system which is energy efficient.

The present invention is an optical keypad assembly to access a car, comprising:
a plurality of keys, each key comprising at least an emitter for emitting visible light and an associated receiver for receiving reflected visible light,
a processing unit for controlling emitters and receivers and for determining if a key has been selected by analysing signal generated by the receiver of said key; keys successively selected constituting an identification code entered by a user to access the car.

The visible spectrum is the portion of the electromagnetic spectrum that is visible to the human eye. Electromagnetic radiation in this range of wavelengths from about 400 to 800 nm is called visible light. In the meaning of the present invention, infrared waves are not included in this range. As visible light is used, the optical keypad according to the invention works with all types of windscreen including:
athermal windscreen that has a thin metal layer blocking radio waves, near infrared and UV radiation, and
all types of windscreen which contains a metal foil, such as heating windscreens.

In other words, the keyboard measures the reflection of visible light through any type of windscreen and on the finger of the user. Visible light is emitted by LEDs (Light Emitting Diodes) and received by phototransistors or photodiodes.

The keypad according to the invention is contactless and is able to detect an identification code entered by an user for demobilizing a rental car : by opening the door, by rendering the engine available.

The optical keypad according to the invention proposes a new access system for which the installation is fully reversible and not harmful to the vehicle. Indeed it does not need to cross the bodywork or any joint as it runs through the windscreen. In fact, for a car rental company, the resale value of the vehicle decreases due to any damage to the vehicle.

Preferably, the visible light emitted by the emitter is amplitude modulated to distinguish the useful signal from ambient light. A coherent demodulation may be applied to determine an envelope signal generated by the receiver, this envelope being the useful signal.

In particular, the invention also proposes a method for use the optical keypad assembly by:
successively activating an emitter and an associated receiver during a predetermined period of time for emitting a visible light and detecting the reflected visible light, and
comparing the signal from the receiver with a value.

According to an embodiment of the invention, the comparing step may consist in comparing the value of the detected light intensity when the emitter is active and the value of the detected light intensity when the emitter is turned off. A simple implementation is to measure the light intensity value when LED turned on then subtracting to this value the intensity measured with the LED off. This method is equivalent to a coherent demodulation of amplitude according to the prior art.

Advantageously, the value of the detected light intensity when the emitter is turned off is obtained by determining the average of several values of detected light intensity when the emitter is turned off.

In a preferred embodiment, an analog-to-digital converter (ADC) of a microcontroller in the processing unit is used for detecting by current mode the signals generated by the receiver. A current mode measurement provides better linearity to the receiver.

According to an advantageously embodiment of the present invention, in order to optimize power consumption and a better signal to noise ratio, the supply current of emitters and receivers may be automatic controlled by the ambient light which is measured by the average luminous flux received by the receivers. In very bright atmosphere, the LED current is maximum, it is minimum in dark atmosphere. An embodiment of the LEDs power supply can be a PWM (Pulse Width Modulation) output of a microcontroller which is filtered to keep its continue component, this latter is amplified and modulated to power the LEDs.

According to a preferred embodiment of the invention, the assembly further comprises a capacitive sensor for detecting the presence of nearby body without any physical contact, the processing unit being configured to switch from a sleep state to an active state in response to a signal coming from the capacitive sensor. Such a capacitive proximity sensor is used to minimize power consumption. It may be an electrode covering the surface of the keypad. Preferably, the capacitive sensor is distributed in the assembly.

According to another embodiment of the invention, the assembly further comprises a RFID antenna to communicate with an external RFID tag. Thus, the user may use an identification code or a RFID tag if possible.

Preferably, the RFID antenna has a circular shape around (without overlapping) components used for managing the visible light; and wherein the capacitive sensor has a star shape in order to limit electromagnetic coupling with the RFID antenna, the capacitive sensor overlapping components used for managing the visible light. The components used for managing the visible light comprise the emitters and the receivers and others electronic components included in the assembly.

The decoupling of the RFID antenna and the capacitive sensor permits to minimize power consumption and not to degrade the sensitivity of the RFID antenna. Indeed the capacitive sensor is preferably a metal part which is traversed by induced currents. With the capacitive sensor in a star shape centered in the middle of the circular RFID antenna, metal parts of capacitive sensor are perpendicular to the conductors of the RFID antenna. This geometry minimizes the induced currents flowing parallel to induce currents.

Moreover, for conductors which are not parallel to the RFID antenna, the negative effect on the RFID antenna is reduced by inserting inductances into the wiring of emitter and receiver circuits, for example 470 nH typical value for an antenna operating at 13.56 MHz.

According to another embodiment of the invention, the RFID antenna may be placed next to the keypad to avoid interference with the electronics of the keypad.

According to the invention, the assembly comprises a temperature sensor for compensating for thermal drift of the emitters and receivers.

In order to indicate the state of the keypad during a processing, the assembly further comprises signaling diodes.

The assembly may further comprise adhesive means for pressing the assembly behind the windscreen without gap. When the assembly is made from a flexible board, it can easily and properly match any shape of the windscreen.

For the purpose of illustrating the invention, there is shown in the drawings a form that is presently preferred; it being understood, however, that this invention is not limited to the precise arrangements and instrumentalities.

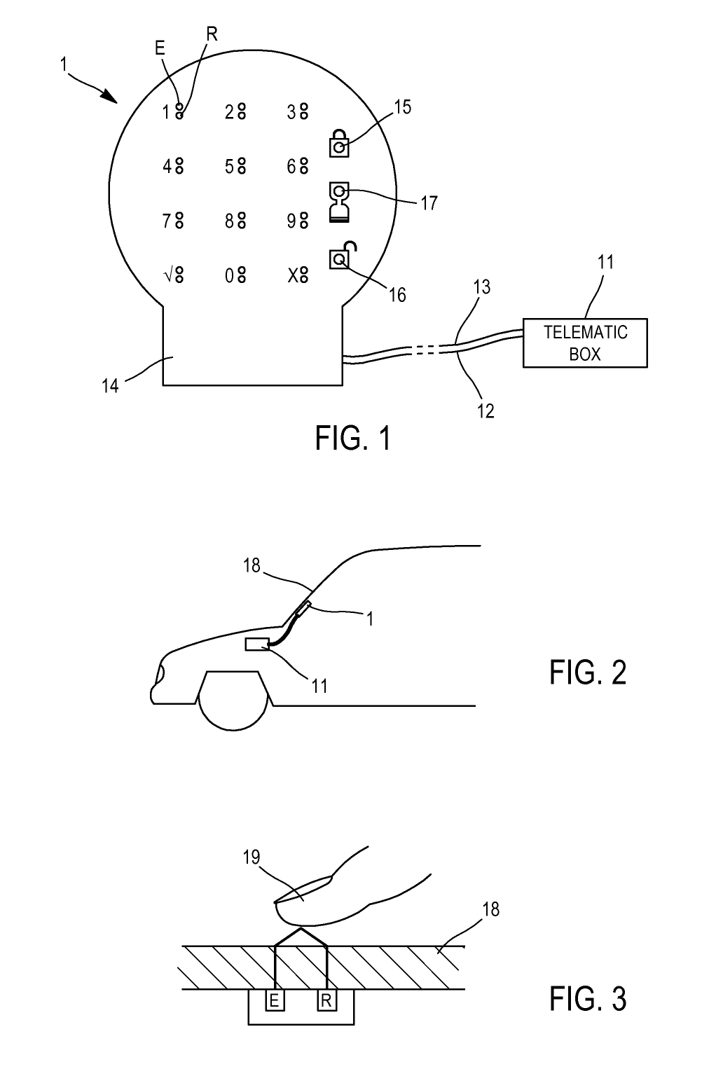

FIG. 1 is a schematic view illustrating a keypad assembly connected to a telematic box for opening the car when the identification code entered by a user is correct, according to the present invention;

FIG. 2 is a schematic view illustrating a keypad assembly pressed under a windscreen of a rental car, the telematic box being integrated in the car and connected to the board computer of the car, according to the invention;

FIG. 3 is a schematic view illustrating one key of the keypad assembly, said key comprises one emitter and one receiver pressed against the windscreen, without a gap between the windscreen and the emitter/receiver, according to the invention;

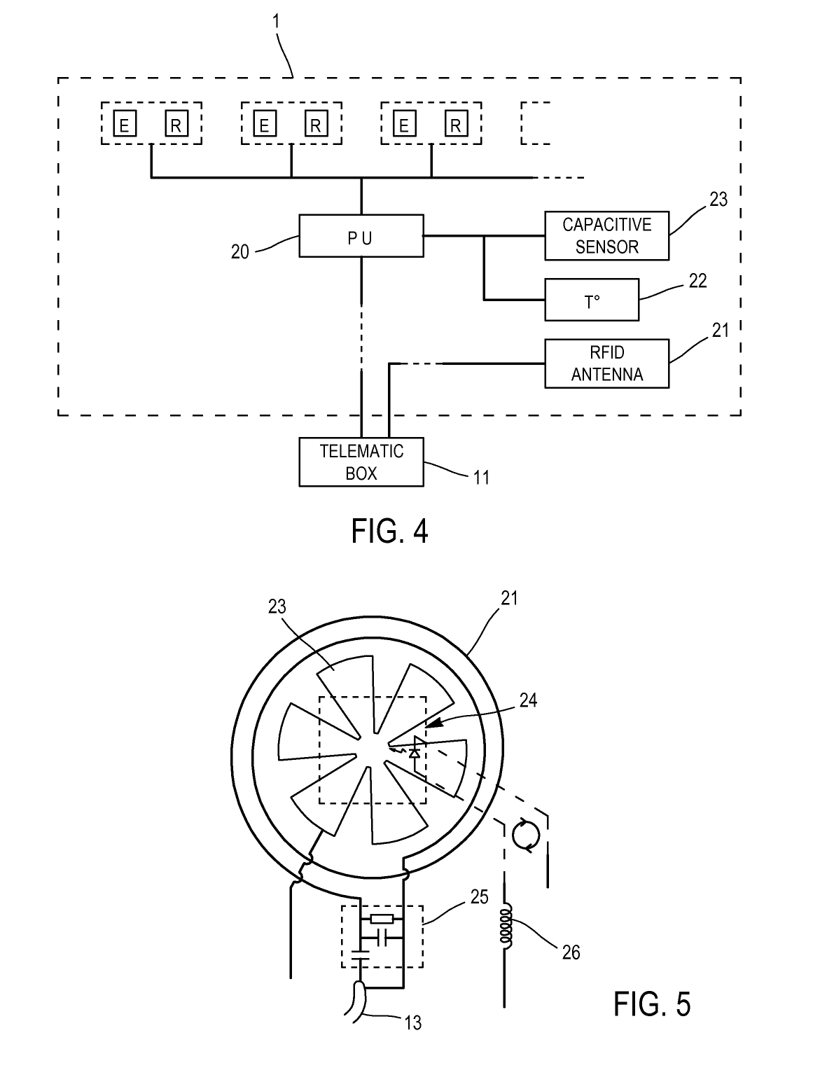

FIG. 4 is a schematic block diagram of the electronic components according to the invention;

FIG. 5 is a simplified view of a capacitive antenna together with a RFID antenna;

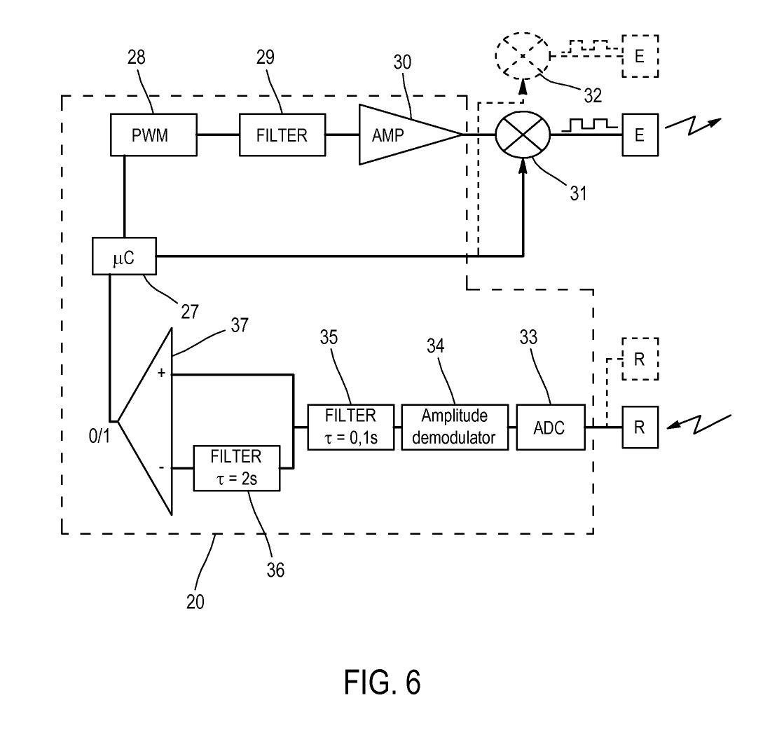

FIG. 6 is a schematic view illustrating electronic processing of signal used to excite the emitter and signal detected by the receiver.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention as defined by the appended claims.

In accordance with the preferred embodiment, the device according to the invention is globally referenced by 1 on FIG. 1.

The keypad assemble 1 is made with a flexible board with thin electronic components such that it has a thickness of only a few millimeters. FIG. 1 illustrates the outer face of the keypad assembly, the face intended to be pressed under the windscreen, inside the car. This outer face is thus visible from a user outside the car. FIGS.: 1, 2, 3, 4, 5, 6, 7, 8, 9 and 0 are inscribed on the outer face which may be designed from plastic material or other. A check mark “√” and a sign of correction “X” are also listed on the outer face. Next to each figures and signs are two apertures. The first aperture receives an emitter E. The second aperture receives a receiver R.

The use of the keypad assembly may be as follows. A user who wishes to reserve a car connects to the Internet to make his reservation. Following booking process, he obtains an identification code on the Internet or by SMS for example. With its identification code, he arrives to a rental location to take possession of the reserved car. The user shall use the identification code to activate the opening of doors and unlock the system to start the car.

On FIG. 1, a telematic box 11 is illustrated for communication with an onboard computer to control the car door opening and unlocking system to start the car. To do this, the telematic box 11 must check whether the user has the correct identification code predefined in the telematic box 11. The keypad assembly is used by the user to enter his identification code which is then transmitted to the telematic box 11. As discussed below, the keypad assembly includes a processing unit capable of detecting the figures entered by the user and to communicate them to the telematic box 11 via a data bus 12. The lower part 14 of the keypad assembly 1 is adapted to receive a battery. The communication between the keypad assembly and the telematic box may be a wireless communication. In another embodiment, the power supply may come from the telematic box 11. FIG. 2 illustrates a front part of car. The keypad assembly 1 according to the present invention is disposed under the windscreen 18. The telematic box may be arranged in a hard to reach area of the car.

According to the invention, it is provided inside the keypad assembly a RFID antenna (not shown on FIG. 1) to communicate with a RFID tag if the user has such a tag. Preferably, electronic components intended to control the RFID antenna are disposed inside the telematic box to avoid being exposed to high temperatures under the windscreen. The connection between the RFID antenna inside the keypad assembly and the telematic box 11 consists in a coaxial cable 13.

Signaling LEDs are arranged on the outer face to indicate:
if the car is locked (no correct identification code entered), the LED 15 corresponding to the image of a closed key lights up;
if the identification code is correct, the car opens, the LED 16 corresponding to the image of a opened key lights up;
if the processing unit or the telematic box 11 is processing, the LED 17 corresponding to the image of a timer lights up.

FIG. 3 shows how a visible light travels from the emitter to the receiver through the glass thickness of the windscreen 18. When the emitter E is activated, a visible light is generated from the emitter E to outside. If there is an obstacle as a finger 19, the light is reflected to the keypad assembly. Some radiation return to the keypad assembly, to the receiver R associated to the emitter E. The emitter E and the receiver R are associated together because they constitute one key.

Referring now to FIG. 4, a bloc diagram according to the invention is shown.

The keypad assembly 1 includes a series of couples emitters-receivers that are managed by a processing unit 20. The RFID antenna 21 is connected to the telematic box 11.

The temperature sensor 22 detects the room temperature, which is transmitted to the processing unit. This latter uses the room temperature to perform a software correction of the temperature drift of the emitters and the receivers, their transfer function depending on the temperature.

The capacitive sensor 23 is used to limit the power consumption of the keypad assembly. This is a proximity sensor which detects the approach of the user finger. In the absence of finger, the processing unit is in standby (sleep) mode for which no signal is sent to the emitter. For example, during the standby mode, the emitters and receivers may not be activated. In case of approach of a finger or a fortiori of contact, the processing unit activates the emitters and receivers to achieve the detection of keys entered by the user. In particular, the processing unit successively fed all emitters with an excitation signal. The processing unit provides a processing window for each key, that is to say, an emitter-receiver pair. During this window, one begins by measuring the intensity of the light received by the receiver so as to obtain the intensity level of ambient light when the emitter is off. Then the emitter is fed to measure the light intensity level detected by the receiver.

The intensity level obtained emitter switched off is compared with an average of light intensity levels obtained emitter off. This avoids systematic calibration operations that would be due to the difference in thickness between windscreens. With this principle of subtraction of time-averaged, only rapid changes are retained, changes associated to the presence of the user's finger in front of the keys. The useful signal thus obtained after subtraction is then compared to a predetermined threshold to validate or not if a key has been selected.

FIG. 5 illustrates an advantageous embodiment of the invention. The RFID antenna 21 is constituted by a conductive element forming one or more circular loops. The RFID antenna is produced on an electronic board which comprises all electronic components. An RLC circuit 25 is arranged on a branch of the RFID antenna so as to provide impedance matching with the coaxial cable 13 for example. The RLC circuit 25 is arranged on a branch of the RFID antenna so as to provide impedance matching with the coaxial cable 13 for example. The circuit 25 is a quadritail circuit comprising for example a resistance and two capacitances.

Inside the circle formed by the RFID antenna 21, the capacitive sensor 23 is disposed without overlapping the RFID antenna. The capacitive sensor is made with metallic material and has a star shape centered in the middle of the RFID antenna. The branches of the capacitive sensor are almost perpendicular to the conductive element of the RFID antenna. This geometry minimizes the induced currents that flow preferentially parallel to the inductor currents. The lines of inducing currents in the RFID antenna flow perpendicular to branches of the capacitive sensor. Due to minimized induced currents, the electromagnetic coupling between the capacitive sensor and the RFID antenna is limited in order to maintain the sensitivity of the latter.

In the center of the circle formed by the RFID antenna 21, is also arranged a set of electronic components 24 such as visible light emitters and receivers and possibly the processing unit and other electronic components known in prior art. This set of electronic components 24 may include conductive elements that disrupt the RFID antenna because these conductive elements produce an electromagnetic coupling. To avoid this, an inductor named inductor plug 26 is inserted mainly on conducting elements used for managing the emitters and receivers. For example, in FIG. 5, an inductor is inserted in a loop formed by a branch of the electronic circuit to neutralize the induced current. For example, the loop may be the one that powers a LED keypad. The inductor can also be placed in the RFID antenna or adjacent to, but always in the electronic circuit. Typically, the value of the inductor is 470 nH for an antenna operating at 13.56 MHz.

FIG. 6 illustrates in more detail some of the electronic architecture of the keyboard according to the invention. The processing unit 20 includes a microcontroller 27 to control emitters and receivers. For the emission, a pulse width modulator PWM 28 is used for generating a low-power squared signal which is then filtered by the low-pass filter 29. The amplifier 30 amplifies the signal to a level enough to sequentially supply the emitters one after the other. The microcontroller is configured for routing the squared signal on a plurality of transmitters by means of a set of multipliers 31, 32.

On reception, the analog signal from the receiver R is converted into a digital signal by means of an analog-to-digital converter 33. The amplitude demodulator 34 performs a coherent demodulation and subtract from the useful signal a signal obtained by averaging several measured signals when the emitter is off. Then, a first filtering 35 is carried out to remove any electronic disturbance. Then a comparator 37 is fed with, on the one hand the signal from the first filter 35, and on the other hand a signal from a second low-pass filter 36 which is fed by the signal from the first filter 35. The second filter 36 is of first order with a delay of two seconds. The output of comparator 37 is a 0/1 signal that is collected by the microcontroller 27.

The present invention provides a system for vehicle access. Advantageously, it comprises an optical keypad and an RFID antenna working through a windscreen which can be athermal including a thin metal layer. The keypad measures the reflection of visible light on the fingers of the user. The keypad assembly has very low power consumption as it comprises a capacitive sensor for a standby mode. The capacitive sensor shape limits the induction with the RFID antenna.

The present invention therefore proposes a new access system for which the installation is fully reversible and not harmful to the vehicle. Indeed it does not need to cross the car body or any joint.

Numerous variations and modifications will become apparent to those skilled in the art once the above disclosure is fully appreciated. It is intended that the following claims be interpreted to embrace all such variations and modifications.

1. An optical keypad assembly to access a car, comprising:
a plurality of keys, each key comprising at least an emitter for emitting visible light and an associated receiver for receiving reflected visible light;
a processing unit configured for controlling emitters and receivers and for determining if a key has been selected by analysing signal generated by the receiver of said key; and
said keys successively selected constituting an identification code entered by a user to access the car,

2. The assembly according to claim 1, wherein the visible light emitted by the emitter is amplitude modulated, and the assembly further comprises a coherent demodulator to determine an envelope signal generated by the receiver.

3. The assembly according to claim 1, wherein it further comprises a capacitive sensor configured for detecting the presence of nearby body without any physical contact, the processing unit being configured to switch from a sleep state to an active state in response to a signal coming from the capacitive sensor.

4. The assembly according to claim 3, wherein the capacitive sensor is distributed in the assembly.

5. The assembly according to claim 1, further including a RFID antenna configured to communicate with an external RFID tag.

6. The assembly according to claim 4, wherein the RFD antenna has a circular shape around components used for managing the visible light; and wherein the capacitive sensor has a star shape in order to limit electromagnetic coupling with the RFID antenna, the capacitive sensor overlapping components used for managing the visible light.

7. The assembly according to claim 1, further including a temperature sensor for compensating for thermal drift of the emitters and receivers.

8. The assembly according to claim 5, wherein inductances are inserted into the wiring of emitter and receiver circuits for reducing the negative effect of conductors on the RFID antenna.

9. The assembly according to claim 1, further including adhesive means for pressing the assembly behind a windscreen without gap, the assembly being made from a flexible board.

10. A method for accessing a car by using an optical keypad assembly comprising a plurality of keys, each key comprising at least an emitter for emitting visible light and an associated receiver for receiving reflected visible light, and a processing unit for controlling emitters and receivers and for determining if a key has been selected by analysing signal generated by the receiver of said key; keys successively selected constituting an identification code entered by a user to access the car;
the method comprising following steps:
successively activating an emitter and an associated receiver during a predetermined period of time for emitting a visible light and detecting the reflected visible light;
comparing the signal from the receiver with a value.

11. The method according to claim 10, wherein the comparing step consists in comparing the value of the detected light intensity when the emitter is active and the value of the detected light intensity when the emitter is turned off.

12. The method according to claim 11, wherein the value of the detected light intensity when the emitter is turned off is obtained by determining the average of several values of detected light intensity when the emitter is turned off.

13. Method The method according to claim 10, wherein the supply current of emitters and receivers is automatic controlled by the ambient light which is measured by the average luminous flux received by the receivers.

14. The method according to claim 10, wherein it comprises the step of modulating the amplitude of the visible light emitted by the emitter, and the step of carrying out a coherent demodulation of the signal generated by the receiver.

15. The method according to claim 10, wherein the emitter and the receiver are activated for a predetermined period of time only when the presence of a nearby body without any physical contact is detected.
